(19) United States
(12) Patent Application Publication
(10) Pub. No.: US 2012/0121133 A1
(43) Pub. Date: May 17, 2012

(54) SYSTEM FOR DETECTING VARIATIONS IN THE FACE AND INTELLIGENT SYSTEM USING THE DETECTION OF VARIATIONS IN THE FACE

(75) Inventors: Heung-Joon PARK, Gyeonggi-do (KR); Cheol-Gyun OH, Gyeonggi-do (KR); Ik-Dong KIM, Gyeonggi-do (KR); Jeong-Hun PARK, Gyeonggi-do (KR); Yoon-Kyung SONG, Seoul (KR)

(73) Assignee: CRASID CO., LTD., Gyeonggi-do (KR)

(21) Appl. No.: 13/356,358

(22) Filed: Jan. 23, 2012

(30) Foreign Application Priority Data
Aug. 4, 2009 (KR) 10-2009-0071706

(51) Int. Cl. G06K 9/46

(52) U.S. Cl. 382/103; 382/195; 901/47

(57) ABSTRACT

A face change detection system is provided, comprising an image input unit acquiring a plurality of input images, a face extraction unit extracting a face region of the input images, and a face change extraction unit detecting a face change in the input images by calculating an amount of change in the face region.

### RELATED APPLICATIONS

This application is a U.S. National Stage application of International Application NO. PCT/KR2010/005022, filed on 30 Jul., 2010, which claims the priority of Korean Patent Application No. 10-2009-0071706, filed on 4 Aug., 2009, the disclosure of which is incorporated herein by reference in its entirety.

### TECHNICAL FIELD

The present invention relates to a face change detection system and an intelligent system using face change detection, and more particularly, to a face change detection system for detecting a face change in real time and an intelligent system for controlling a device using the face change detection system.

### BACKGROUND ART

With the development of an information society, the importance of a technology for verifying the identity of a person is increasing. Accordingly, biometric technologies that use physical traits of an individual to protect personal information and verify the identity of the individual using a computer are being researched. Of the biometric technologies, face recognition technology may be convenient since it verifies the identity of a user in a non-contact manner while other recognition technologies (such as fingerprint recognition and iris recognition) require a user to carry out a particular motion or action.

As one of core multimedia database search technologies, the face recognition technology can be used in face information-based video summarization, image search, security, surveillance systems, and the like.

However, most interest in face recognition is focused on authentication and security. Thus, not much research has been conducted on applications using face recognition. Furthermore, the result of face recognition is greatly affected by the angle or lighting in which images were captured. Thus, face recognition may require a high-specification, high-performance system.

In this regard, a system which is focused on applications using face recognition and can be implemented in real time is needed.

### DISCLOSURE

### Technical Problem

Aspects of the present invention provide a face change detection system which can reduce resources used to detect a face change in a plurality of images.

Aspects of the present invention also provide an intelligent system which operates a device according to a detected face change.

However, aspects of the present invention are not restricted to the one set forth herein. The above and other aspects of the present invention will become more apparent to one of ordinary skill in the art to which the present invention pertains by referencing the detailed description of the present invention given below.

### Technical Solution

According to an aspect of the present invention, there is provided a face change detection system comprising an image input unit acquiring a plurality of input images, a face extraction unit extracting a face region of the input images, and a face change extraction unit detecting a face change in the input images by calculating an amount of change in the face region.

According to another aspect of the present invention, there is provided a face change detection system comprising an image input unit acquiring a first input image and a second input image, a face extraction unit extracting a face region of the first input image as a first main frame, a face region tracking unit extracting a face region of the second input image as a second main frame by tracking the first main frame, and a face change extraction unit determining whether a face change has occurred using a first change amount calculated as a difference between the first main frame and the second main frame and determining a type of the face change using a second change amount calculated as a difference between a subframe, which contains an eye region or a mouth region, in the first main frame and the subframe in the second main frame.

According to still another aspect of the present invention, there is provided a intelligent system using face change detection. The system comprises a camera acquiring a plurality of input images, a face change detection unit detecting a type of a face change by processing the input images, a response action generation unit generating a response action for controlling a device according to the detected type of the face change, and a response action transmission unit transmitting the generated response action to the device.

### DESCRIPTION OF DRAWINGS

The above and other aspects and features of the present invention will become more apparent by describing in detail exemplary embodiments thereof with reference to the attached drawings, in which:

FIG. 1 is a block diagram of a face change detection system according to an embodiment of the present invention;

FIG. 2 illustrates a main frame and subframes extracted by the face change detection system of FIG. 1;

FIG. 3 is a block diagram of a face change extraction unit included in the face change detection system of FIG. 1;

FIG. 4 illustrates an example of detecting an eye blink in a subframe of an eye region extracted according to an embodiment of the present invention;

FIG. 5 illustrates an example of detecting the opening or shutting of a mouth in a subframe of a mouth region extracted according to an embodiment of the present invention;

FIG. 6 illustrates an example of detecting a vertical face movement based on the movement of a subframe extracted according to an embodiment of the present invention;

FIG. 7 illustrates an example of detecting a horizontal face movement based on the movement of a subframe extracted according to an embodiment of the present invention;

FIG. 8 is a block diagram of an intelligent system using face change detection according to an embodiment of the present invention; and

FIG. 9 illustrates a lookup table of response actions corresponding respectively to face changes.

### MODE FOR INVENTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Throughout the specification, like reference numerals in the drawings denote like elements.

Hereinafter, a face change detection system and an intelligent system using face change detection according to exemplary embodiments of the present invention will be described with reference to block diagrams or flowchart illustrations. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

The term ‘unit’ or ‘module’, as used herein, means, but is not limited to, a software or hardware component, such as a Field Programmable Gate Array (FPGA) or Application Specific Integrated Circuit (ASIC), which performs certain tasks. A unit or module may advantageously be configured to reside on the addressable storage medium and configured to execute on one or more processors. Thus, a unit or module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units or modules may be combined into fewer components and units or modules or further separated into additional components and units or modules.

Hereinafter, exemplary embodiments of the present invention will be described in further detail with reference to the attached drawings.

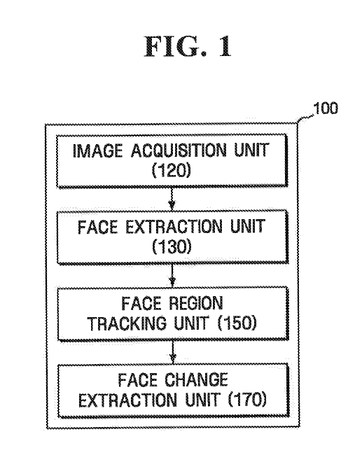

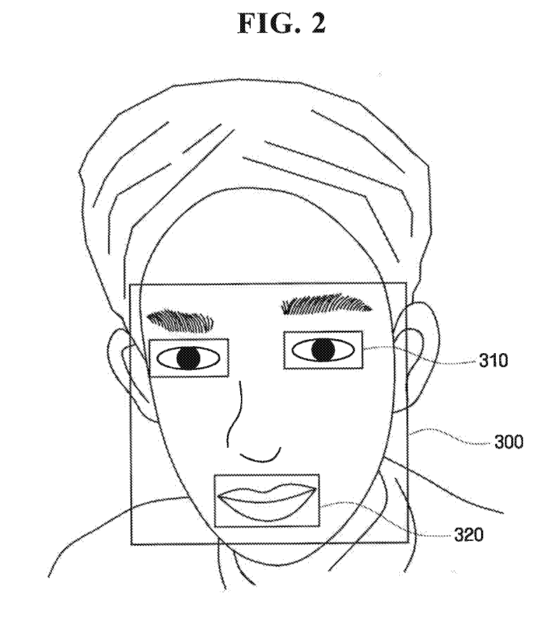

FIG. 1 is a block diagram of a face change detection system 100 according to an embodiment of the present invention. FIG. 2 illustrates a main frame and subframes extracted by the face change detection system 100 of FIG. 1.

Referring to FIGS. 1 and 2, the face change detection system 100 according to the current embodiment may include an image acquisition unit 120, a face extraction unit 130, a face region tracking unit 150, and a face change extraction unit 170.

The image acquisition unit 120 acquires a plurality of input images. The image acquisition unit 120 may acquire a plurality of input images using an image input sensor or acquire all or some images of a video photographed for a predetermined period of time.

The image acquisition unit 120 may acquire a plurality of input images for a predetermined period of time. For example, when at least one eye blink is expected to occur in ten seconds, the image acquisition unit 120 may acquire a plurality of successive input images for at least ten seconds. In addition, the face change detection system 100 according to the current embodiment may generate a sound for inducing or instructing a user to intentionally change his or her face and provide the generated sound to the user. When the user intentionally changes his or her face (for example, blinks his or her eyes or opens or shuts his or her mouth) or when the face of the user changes, the image acquisition unit 120 may acquire a plurality of input images.

When using the image input sensor, the image acquisition unit 120 may acquire an input image by converting an image signal of a subject incident through a lens into an electrical signal. Examples of the image input sensor may include a charge coupled device (CCD), a complementary metal oxide semiconductor (CMOS), and other image capture devices known to those of ordinary skill in the art. In addition, the image acquisition unit 120 may acquire an input image by using an analog/digital converter which converts an electrical signal obtained by the image input sensor into a digital signal and a digital signal processor (DSP) which processes the digital signal output from the analog/digital converter.

The image acquisition unit 120 may convert an acquired input image into a signal-channel image. For example, the image acquisition unit 120 may convert an input image into a grayscale image. When the input image is a multi-channel image of an ‘RGB’ channel, the image acquisition unit 120 may convert the input image into values of one channel. Since an input image is converted into intensity values of one channel, the brightness distribution of the input image can be easily represented.

The face extraction unit 130 extracts a face image from each of a plurality of input images. The face extraction unit 130 may roughly detect a face in each input image. Then, the face extraction unit 130 may extract certain parts (such as eyes, nose and mouth) of the face and extract a face region as a main frame 300 based on the extracted parts of the face. For example, if positions of two eyes are detected, the distance between the two eyes can be calculated. Based on the calculated distance between the two eyes, the face extraction unit 130 may extract the face region from an input image as the face image, thereby reducing the effect of changes in the background of the input image or the hairstyle of a person. The face extraction unit 130 may normalize the size of the face region using information about the extracted face region. By normalizing the size of the face region, the face extraction unit 130 can extract unique characteristics, such as the distance between the two eyes and the distance between the eyes and nose, from the face region at the same scale level.

Furthermore, the face extraction unit 130 may designate and extract each region, which includes a part (e.g., eyes and mouth) of the face, as a subframe. For example, a region including the eyes may be designated as a first subframe 310, and a region including the mouth may be designated as a second subframe 320.

The face region tracking unit 150 tracks the main frame 300 in a plurality of input images. When receiving a plurality of successively or unsuccessively acquired input images of the same person, the face region tracking unit 150 may track the main frame 300 instead of processing each input image. This can reduce the processing time. Extracting the face region from each input image of the same person in order to detect a change in the face of the person may increase the load of the system 100. Therefore, in the current embodiment of the present invention, the face region is not extracted from each input image. Instead, the main frame 300 regarded as the face region is tracked, thus reducing the burden of having to process each input image.

In an example of tracking a face region, the contours of a face are extracted from the main frame 300 of a first input image from which a face region was first extracted. Then, the contours of the face are extracted from the main frame 300 of a subsequent input image in which a change in the face may be detected. Based on the extracted contours, the movement of a contour region of the face is detected. Thus, the position of the main frame 300 in the subsequent input image is moved by a distance by which the contour region of the face was moved. In this way, the face region can be tracked.

In another example of tracking a face region, color information is extracted from the main frame 300 of a first input image from which a face region was first extracted. Then, the color information is extracted again from the main frame 300 of a subsequent input image in which a change in the face may be detected. Based on the extracted color information, the movement of pixel groups, which have the same color information as those of the first input image, in the subsequent input image is detected. Thus, the main frame 300 in the subsequent input image is moved by a distance by which the color information was moved. In this way, the face region can be tracked in a plurality of successively acquired input images.

As described above, in the current embodiment of the present invention, there is no need to extract a face region from each input image. Instead, the face region can be continuously extracted by extracting the face region from a first input image as the main frame 300 and then tracking the main frame 300 in each subsequent input image.

The face change extraction unit 170 detects a face change based on an amount of change in a face region. The face change extraction unit 170 may extract a first change amount from the main tracked frame 300 and determine whether a face change has occurred based on the first change amount. In addition, the face change extraction unit 170 may extract a second change amount from each of the subframes 310 and 320 in the main frame 300 and detect a specific type of the face change based on the second change amount. Here, the specific type of the face change refers to a category of the face change. Examples of the type of the face change may include eye blinks, mouth opening or shutting, a horizontal face movement, and a vertical face movement.

As described above, the face change extraction unit 170 may determine whether a face change has occurred in an input image based on the first change amount and detect the type of the face change based on the second change amount.

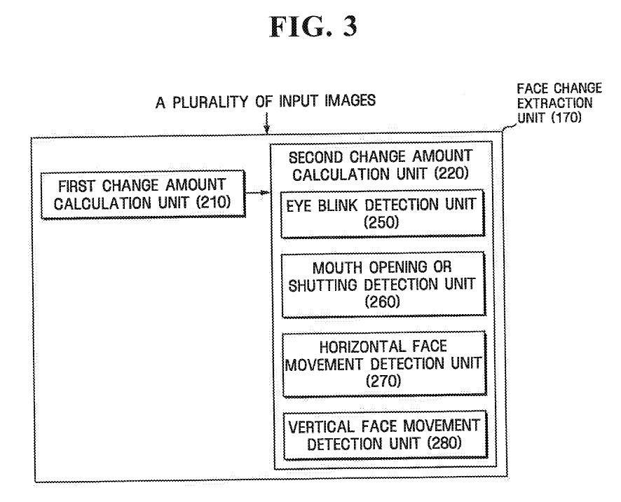

FIG. 3 is a block diagram of the face change extraction unit 170 included in the face change detection system 100 of FIG. 1. Referring to FIG. 3, the face change extraction unit 170 may include a first change amount calculation unit 210 and a second change amount calculation unit 220.

The first change amount calculation unit 210 calculates a first change amount in a main frame of each input image and compares the calculated first change amount with a first threshold value. Based on the comparison result, the first change amount calculation 210 detects a change in a face region.

In the current embodiment of the present invention, the main frame 300 of a first input image from which the face region was first extracted is stored. Then, the main frame 300 in each subsequent input image in which a face change may be detected is tracked and stored. For example, the subsequent input images may be second through fifth input images.

The first change amount calculation unit 210 calculates a difference between a second main frame of the second input image and a first main frame of the first input image. In addition, the first change amount calculation unit 210 calculates a difference between a third main frame of the third input image and the first main frame of the first input image. The first change amount calculation unit 210 performs the same calculation on the fourth input image and the fifth input image. Here, the difference is defined as an image difference between the first main frame and each of the second through fifth main frames, and the image difference may be calculated as the first change amount by adding or taking the average of differences in color at the same positions or grayscale levels between the first main frame and each of the second through fifth main frames.

The first change amount calculation unit 210 outputs the first change amount, that is, the result of each calculation (e.g., first through fifth result values). When the first change amount is greater than the first threshold value, the first change amount calculation unit 210 determines that a face change has occurred in a corresponding input image. For example, when the first through fourth result values are smaller than the first threshold value, the first change amount calculation unit 210 determines that no face change has occurred. When the fifth result value is greater than the first threshold value, the first change amount calculation unit 210 determines that a face change has occurred.

The first change amount calculation unit 210 obtains a plurality of input images for a predetermined period of time and selects an input image having a largest first change amount. Therefore, if a user is blinking his or her eyes or opening or shutting his or her mouth, only an input image having a largest first change amount may be selected and compared with the first input image.

When the first change amount calculation unit 210 determines that a face change has occurred, it sends a corresponding input image or a main frame of the corresponding input image to the second change amount calculation unit 220.

The second change amount calculation unit 220 determines the type of a face change by calculating the amount of change in each of the subframes 310 and 320 in the main frame 300 as the second change amount. The second change amount calculation unit 220 may include an eye blink detection unit 250, a mouth opening or shutting detection unit 260, a horizontal face movement detection unit 270, and a vertical face movement detection unit 280. The second change amount is calculated as a difference between a subframe of the first input image and a subframe of each subsequent input image in which a face change may be detected. For example, the second change amount may be calculated as a difference in color at the same position between the subframe of the first input image and the subframe of each subsequent input image or as a change in the position of the subframe resulting from the movement of the subframe.

In the second change amount calculation unit 220, the eye blink detection unit 250 detects eye blinks, the mouth opening or shutting detection unit 260 detects the opening or shutting of the mouth, the horizontal face movement detection unit 270 detects the horizontal movement of the face, and the vertical face movement detection unit 280 detects the vertical movement of the face.

As described above, in the current embodiment of the present invention, whether a face change has occurred is determined based on the first change amount, and a specific type of the face change is determined based on the second change amount. Thus, there is no need to detect a face change in all of a plurality of input images. Since an input image is selected based on the first change amount and the type of a face change is determined based on the second change amount in each subframe of the selected input image, the calculation load is reduced, thus enabling a low-specification computer to detect a face change in real time.

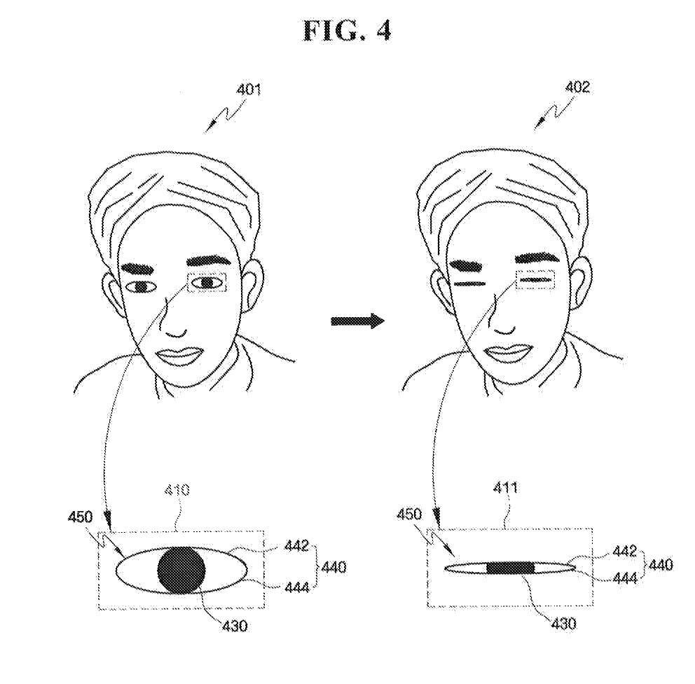

FIG. 4 illustrates an example of detecting an eye blink in a subframe of an eye region extracted according to an embodiment of the present invention.

Referring to FIG. 4, the face extraction unit 130 may extract a first subframe 410, which is an eye region, from a first input image 401. In addition, the face extraction unit 130 may extract a first subframe 411 from a subsequent input image 402 in which a face change was detected based on the first change amount. Each of the extracted first subframes 410 and 411 may include an eye line 440 and/or a pupil 430.

Therefore, the eye blink detection unit 250 of the face change detection unit 170 may detect an eye blink using a change in the size of the pupil 430 or a change in the eye line 440.

For example, when the eye blinks, the size of the pupil 430 exposed is noticeably reduced in the first subframe 411 of the subsequent input image 402 compared with in the first subframe 410 of the first input image 401.

In addition, when the eye blinks, upper and lower parts 442 and 444 of the eye line 440 meet each other and then are separated from each other by a certain distance, thereby forming contours 450 of the eye. Therefore, if a distance between the upper and lower parts 442 and 444 of the eye line 440 is equal to or smaller than a predetermined distance or if a ratio of a minimum distance and a maximum distance is equal to or less than a predetermined value, the eye blink detection unit 250 may determine that an eye blink has occurred. It can be seen from FIG. 4 that the distance between the upper and lower parts 442 and 444 of the eye line 440 is noticeably reduced in the first subframe 411 of the subsequent input image 402 compared with in the first subframe 410 of the first input image 401.

As described above, the eye blink detection unit 250 can detect an eye blink which is one of specific types of a face change by detecting a change in the size of the pupil 430 or a change in the eye line 440.

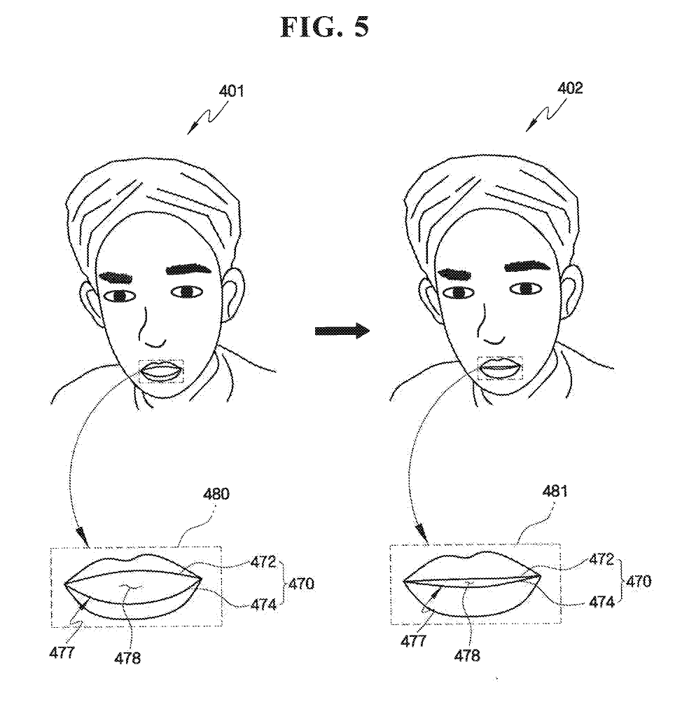

FIG. 5 illustrates an example of detecting the opening or shutting of the mouth in a subframe of a mouth region extracted according to an embodiment of the present invention.

Referring to FIG. 5, the face extraction unit 130 may extract a second subframe 480, which is a mouth region, from the first input image 401. In addition, the face extraction unit 130 may extract a second subframe 481 from the subsequent input image 402 in which a face change was detected based on the first change amount.

The mouth opening or shutting detection unit 260 of the face change detection unit 170 may extract a mouth line 470 from the second subframes 480 and 481 and determine whether the opening or shutting of the mouth has occurred based on the movement of upper and lower parts 472 and 474 of the mouth line 470.

For example, when a distance between the upper and lower parts 472 and 474 of the mouth line 470 is equal to or greater than a predetermined distance, the mouth opening or shutting detection unit 260 may determine that the mouth is open. When the distance between the upper and lower parts 472 and 474 of the mouth line 470 is smaller than the predetermined distance, the mouth opening or shutting detection unit 260 may determine that the mouth is shut. In this way, the mouth opening or shutting detection unit 260 can detect the opening or shutting of the mouth.

Alternatively, the mouth opening or shutting detection unit 260 may detect the opening or shutting of the mouth by using the area of a region 478 inside contours 477 formed by the mouth line 470. When the mouth is shut, the upper and lower parts 472 and 474 of the mouth line 470 contact each other. Thus, the area of the region 478 inside the contours 477 is zero. On the other hand, when the mouth is open, the area of the region 478 enclosed by the contours 477 may have a certain value. Therefore, if a ratio of a minimum area and a maximum area is equal to or less than a predetermined threshold value or if the maximum area is larger than the minimum area by more than a predetermined area, the mouth opening or shutting detection unit 260 may determine that the mouth is being shut or opened.

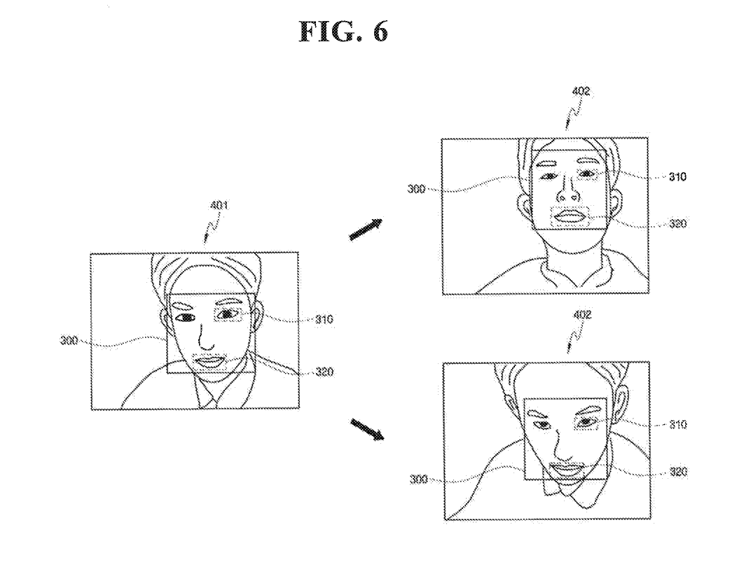

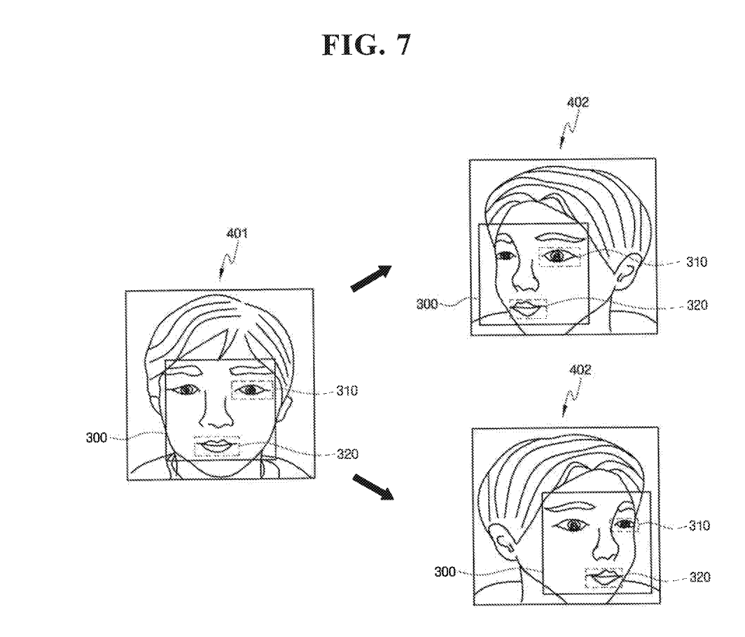

FIG. 6 illustrates an example of detecting a vertical face movement based on the movement of a subframe extracted according to an embodiment of the present invention. FIG. 7 illustrates an example of detecting a horizontal face movement based on the movement of a subframe extracted according to an embodiment of the present invention.

Referring to FIG. 6, the second change amount may be the amount of movement of each of a first subframe and a second subframe in a first input image and a subsequent input image in which a face change was detected based on the first change amount.

For example, if a first subframe 310 of a subsequent input image 402, in which a face change was detected based on a first subframe 310 of a first input image 401, has moved upward and if a second subframe 320 has also moved upward, it may be determined that the face has turned upward.

In addition, if the first subframe 310 of the subsequent input image 402, in which a face change was detected based on the first subframe 310 of the first input image 401, has moved downward and if the second subframe 320 has also moved downward, it may be determined that the face has turned downward.

In FIG. 6, as in FIG. 7, the amount (or amounts) of movement of a first subframe 310 and/or a second subframe 320 may be calculated. If the calculated amount (or amounts) indicates that the first subframe 310 and/or the second subframe 320 has moved to the right or left, it may be determined that the face has turned to the right or left.

As described above, according to the current embodiment, the specific type of a face change can be determined by calculating the amounts of change of the first and second frames 310 and 320. Thus, a face change can be easily detected.

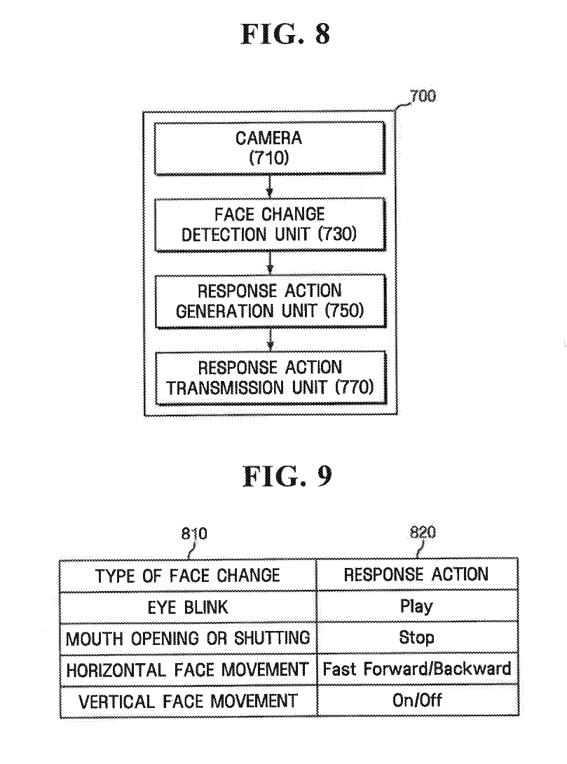

FIG. 8 is a block diagram of an intelligent system 700 using face change detection according to an embodiment of the present invention. Referring to FIG. 8, the intelligent system 700 using face change detection according to the current embodiment of the present invention may include a camera 710, a face change detection unit 730, a response action generation unit 750, and a response action transmission unit 770.

The camera 710 acquires a plurality of input images containing a face. The type of the camera 710 for acquiring input images is not limited to a particular type. For example, a general camera, an infrared camera, or the like can be used to acquire input images.

The face change detection unit 730 detects face changes in a plurality of input images. The face change detection unit 730 may detect various face changes in an extracted face region of a plurality of input images, such as eye blinks, mouth opening or shutting, and the vertical/horizontal movement of the face.

The face change detection unit 730 determines whether a face change has occurred by comparing a first change amount with a threshold value while tracking a main frame in a plurality of input images. Using a second change amount which is a difference between a subframe of a first input image and a subframe of a subsequent input image in which a face change was detected based on the first change amount, the face change detection unit 730 detects a specific type of the face change in the subsequent input image.

The response action generation unit 750 generates a response action 820 according to a type 810 of a detected face change. The response action generation unit 750 may search a lookup table for a response action corresponding to a detected face change and generate the response action.

Referring to FIG. 9, a lookup table of response actions corresponding respectively to various face changes may be stored. In this state, if the type of a face change is detected, the lookup table may be searched to generate a response action.

The response action transmission unit 770 transmits a generated response action to a device that the intelligent system 700 intends to control as a command. The response transmission unit 770 may generate a command suitable for each device controlled by the intelligent system 700 and transmit the generated command to a corresponding device. Here, examples of a device controlled by the intelligent system 700 may include various electronic products (e.g., mobile phones, televisions, refrigerators, air conditioners, and camcorders), portable media players (PMPs), and MP3 players.

The intelligent system 700 using face change detection according to the current embodiment of the present invention can be installed in various devices as an embedded system. That is, the intelligent system 700 can operate as an integral part of each device. In each device, the intelligent system 700 may perform an interface function according to a face change. Therefore, each device controlled by the intelligent system 700 can perform a certain operation according to a face change without requiring an interface such as a mouse or a touch pad.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims rather than the foregoing description to indicate the scope of the invention.

What is claimed is:

1. A face change detection system comprising:
an image input unit acquiring a plurality of input images;
a face extraction unit extracting a face region of the input images; and
a face change extraction unit detecting a face change in the input images by calculating an amount of change in the face region.

2. The system of claim 1, wherein the face extraction unit extracts a face region of a first input image among the input images as a first main frame and further comprising a face region tracking unit extracting a face region of a second input image among the input images as a second main frame by tracking the first main frame.

3. The system of claim 2, wherein the face extraction unit extracts an eye region or a mouth region as a subframe from the first main frame.

4. The system of claim 2, wherein the face change extraction unit comprises a first change amount calculation unit calculating a difference between the first main frame and the second main frame as a first change amount and detecting a face change in the second input image when the first change amount is equal to or greater than a first threshold value.

5. The system of claim 4, wherein the face change extraction unit further comprises a second change amount calculation unit calculating a second change amount by comparing the subframe, which contains the eye region or the mouth region, in the first input image with the subframe in the second input image in which the face change was detected and determining a type of the face change based on the second change amount.

6. A face change detection system comprising:
an image input unit acquiring a first input image and a second input image;
a face extraction unit extracting a face region of the first input image as a first main frame;
a face region tracking unit extracting a face region of the second input image as a second main frame by tracking the first main frame; and
a face change extraction unit determining whether a face change has occurred using a first change amount calculated as a difference between the first main frame and the second main frame and determining a type of the face change using a second change amount calculated as a difference between a subframe, which contains an eye region or a mouth region, in the first main frame and the subframe in the second main frame.

7. An intelligent system using face change detection, the system comprising:
a camera acquiring a plurality of input images;
a face change detection unit detecting a type of a face change by processing the input images;
a response action generation unit generating a response action for controlling a device according to the detected type of the face change; and
a response action transmission unit transmitting the generated response action to the device.

8. The system of claim 7, wherein the face change detection unit detects a face change using a first change amount in a main frame, which contains a face region of the input images, while tracking the main frame.

9. The system of claim 8, wherein the face change detection unit determines a type of the face change using a second change amount in a subframe, which contains an eye region or a mouth region, within the tracked main frame.

10. The system of claim 7, wherein the device is one of a digital television, a robot, a personal computer, a portable media player (PMP), an MP3 player, and an electronic device equipped with the camera.
